(19) United States
(12) Patent Application Publication
(10) Pub. No.: US 2013/0212173 A1
(43) Pub. Date: Aug. 15, 2013

(54) SUGGESTING RELATIONSHIP MODIFICATIONS TO USERS OF A SOCIAL NETWORKING SYSTEM

(71) Applicants: Robert William Carthcart, San Francisco, CA (US); Jonathan A. Coens, San Francisco, CA (US); Mark McDuff, Menlo Park, CA (US); Jacqueline Cerretani Frank, Menlo Park, CA (US)

(72) Inventors: Robert William Carthcart, San Francisco, CA (US); Jonathan A. Coens, San Francisco, CA (US); Mark McDuff, Menlo Park, CA (US); Jacqueline Cerretani Frank, Menlo Park, CA (US)

(21) Appl. No.: 13/372,054

(22) Filed: Feb. 13, 2012

(51) Int. Cl. G06F 15/16

(52) U.S. Cl. 709/204

(57) ABSTRACT

A social networking system includes a tool that assists users in removing friends and/or classifying friends as mere acquaintances. The tool predicts friends that a user is likely to remove or reclassify based on a set of features that has been found to predict this using machine learning algorithms. The set of features in the predictive model may include selected attributes about the users (e.g., declared/profile information, user history, and/or social information). For each user of the social networking system, the user's relationships with other users on the social networking system are ranked based on statistical correlations derived from the predictive model.

### BACKGROUND

This invention relates generally to social networking, and in particular to suggesting relationship modifications to users of a social networking system.

Social relationships between people are dynamic and mutable. What starts as a brief acquaintance may grow into a full-blown friendship and may eventually blossom into a marriage. Social networking systems have enabled users to keep up with their friends over long distances and long periods of time through sharing photos, real-time status updates, and playing social games. However, users' relationships on a social networking system, as in life, may fade. Close friends in their college years may become mere acquaintances decades later.

In recent years, users of social networking systems have shared their interests and engaged with other users of the social networking systems by sharing a plethora of information. The amount of information gathered from users is staggering—information describing recent moves to a new city, graduations, births, engagements, marriages, and the like. As a user accumulates more connections on the social networking system, the user may become flooded with content. Some content may be irrelevant or uninteresting because the user may be connected to distant friends or mere acquaintances that publish this irrelevant and/or uninteresting content. Social networking systems have not provided a tool or method of marking these users as distant friends or mere acquaintances.

Specifically, the information available on social networking systems has not been used to suggest relationship modifications to users of a social networking system. Enabling users to designate varying classifications to their connections on the social networking system is valuable to enhancing the user experience. However, existing systems have not provided users with a tool that predicts changes in these relationships between users on a social networking system.

### SUMMARY

A social networking system includes a tool that assists users in removing friends and/or classifying friends as mere acquaintances. The tool predicts friends that a user is likely to remove or reclassify based on a set of features that has been found to predict this using machine learning algorithms. The set of features in the predictive model may include selected attributes about the users (e.g., declared/profile information, user history, and/or social information). For each user of the social networking system, the user's relationships with other users on the social networking system are ranked based on statistical correlations derived from the predictive model.

### BRIEF DESCRIPTION OF THE DRAWINGS

FIG. 1 is high level block diagram illustrating a process of suggesting relationship modifications to users of a social networking system, in accordance with an embodiment of the invention.

FIG. 2 is a network diagram of a system for suggesting relationship modifications to users of a social networking system, showing a block diagram of the social networking system, in accordance with an embodiment of the invention.

FIG. 3 is high level block diagram illustrating a relationship ranking module that includes various modules for developing a predictive model of suggesting relationship modifications to users of a social networking system, in accordance with an embodiment of the invention.

FIG. 4 is a flowchart of a process of suggesting relationship modifications to users of a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users that are connected on the social networking system may also be referred to as “friends.” Users that are not connected to each other may share mutual friends on the social networking system which may be counted by the social networking system. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with an object may be recorded by the social networking system as an edge. By enabling advertisers to target their advertisements based on user interactions with objects related to a keyword, the advertisements may reach a more receptive audience because the users have already performed an action that is related to the advertisement. For example, a merchandiser that sells Justin Bieber t-shirts, hats, and accessories may target ads for new merchandise to users that have recently performed one of multiple different types of actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is further described in a related application, “Structured Objects and Actions on a Social Networking System,” U.S. application Ser. No. 13/239,340 filed on Sep. 21, 2011, which is hereby incorporated by reference.

As users accumulate connections on the social networking system, often through brief meetings and encounters at social gatherings, their news feeds become inundated with content items posted by their accumulated connections. In order to improve the user experience on the social networking system, users may modify their relationships with other users on the social networking system to indicate the granular nature of social relationships. The social networking system may provide a user interface in which a viewing user may be provided with suggested relationship modifications for connected users. The user interface may include information retrieved from profiles of other users connected to the viewing user that have been ranked by a prediction model to likely be a distant friend or mere acquaintance of the viewing user. In one embodiment, the user interface may include a suggestion to remove a distant friend or mark a connected user as a mere acquaintance. As a result, fewer content items will be published to the viewing user's news feed by acquaintances and no content items will be published to the viewing user's news feed by distant connections once those distant connections are removed. Machine learning, heuristics analysis, and regression analysis may be used in generating a predictive model to suggest relationship modifications to users of a social networking system as described herein.

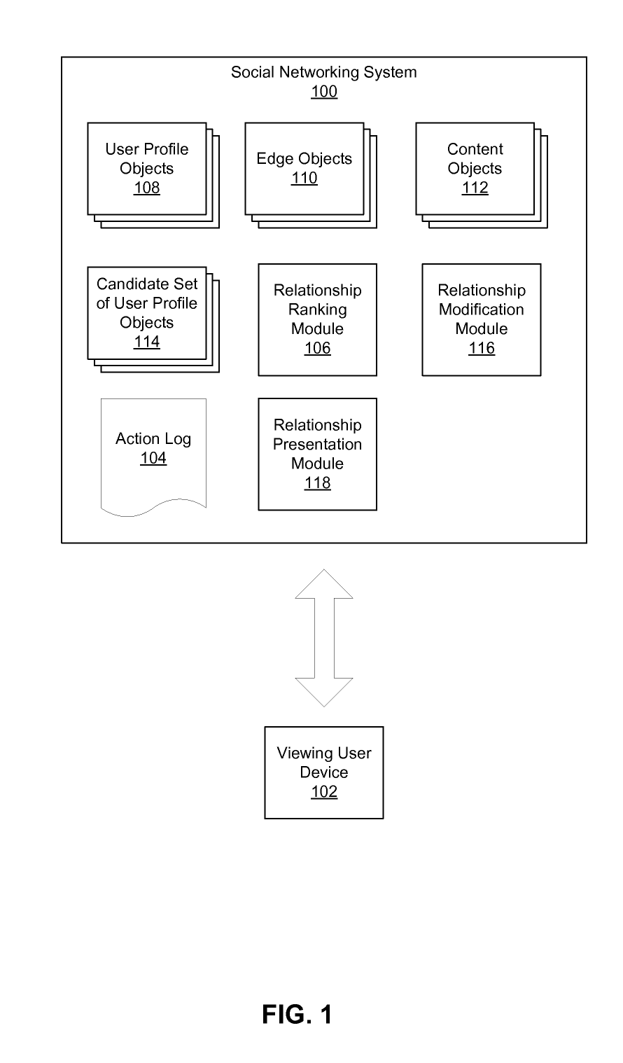

FIG. 1 illustrates a high level block diagram of a process for suggesting relationship modifications to users of a social networking system, in one embodiment. A viewing user device 102 is associated with a user of a social networking system 100 and may provide content published on the social networking system 100 to the user through the viewing user device 102. The social networking system 100 uses different types of information about users in the process of suggesting relationship modifications, including user profile objects 108, an action log 104, edge objects 110, and content objects 112. Each user of the social networking system 100 is associated with a unique user profile object 108. These user profile objects 108 include declarative information about the user that was explicitly shared by the user as well as any profile information inferred by the social networking system 100. In one embodiment, a user profile object 108 may include thirty or more different data fields, each data field describing an attribute of the corresponding user of the social networking system 100.

Users of the social networking system 100 may take actions using the social networking system 100 that are associated with one or more objects. Information describing these actions is stored in the action log 104. The action log 104 includes many different types of interactions with content objects 112 that occur on a social networking system, including commenting on a photo album, communications between users, becoming a fan of a musician, and adding an event to a calendar. Content objects 112 may include custom graph objects that are defined by third-party developers, as mentioned above. The action log 104 records a user's interactions with various content objects 112, including advertisements on the social networking system 100 as well as other applications operating on the social networking system 100.

Edge objects 110 store information about users' connections to other nodes on a social networking system 100. Such information may include the interactions between the user and the connection on the social networking system 100, including wall posts, comments on photos, geographic places where they have been tagged together, and photos in which they have both been tagged in. In one embodiment, an edge object 110 includes information about the strength of the connection between the users, such as an affinity score. If a user has a high affinity score for a particular connection, the social networking system 100 has recognized that the user interacts highly with that connection. Affinity scores and methods of gathering this social data from a social networking system are described further in “Contextually Relevant Affinity Prediction in a Social Networking System,” U.S. application Ser. No. 12/978,265, filed on Dec. 23, 2010, which is hereby incorporated by reference.

A relationship ranking module 106 may be used by the social networking system 100 in developing a prediction model for suggesting relationship modifications to users of a social networking system 100. The prediction model may analyze information gathered from user profile objects 108, the action log 104, edge objects 110, and content objects 112 described above to determine a level of engagement and interaction between the viewing user and connected users. The relationship ranking module 106 may use this engagement analysis as a factor in the prediction model used to suggest relationship modifications to users. As more information is gathered about users of the social networking system 100, the relationship ranking module 106 may be used to alter the prediction model for suggesting relationship modifications, giving more or less weight to a specific attribute or behavior of a user, such as how long a target user has been using the social networking system, the number of mutual friends or connections the target user has with the source user (viewing user), and the time elapsed since the target user last logged into the social networking system. The prediction model may also include other features, such as how long the target user and the source user have been friends on the social networking system, the number of friends on the social networking system accumulated by the source user, the number of friends on the social networking system accumulated by the target user, the amount of time since the target user last updated his profile, the age difference between the target user and the source user, a ratio of common friends in relation to the number of friends accumulated by the target user, a ratio of common friends in relation to the number of friends accumulated by the source user, an age of the target user on the social networking system (e.g., how long the target user has been using the social networking system), and the legal age of the target user. In one embodiment, machine learning methods may be used to determine weights for these features in the prediction model. In another embodiment, separate prediction models may be generated with different weights for suggesting that a user remove a connection on the social networking system and for suggesting that a user mark a connection as an acquaintance. In yet a further embodiment, the prediction model for suggesting relationship modifications to a viewing user may filter connected users for which the viewing user has a high affinity for based on a predetermined threshold affinity score. The remaining connected users may then be ranked according to the prediction model, and the top ranking users for relationship modification may comprise a candidate set of suggested users, associated with a candidate set of user profile objects 114. In one embodiment, the prediction model produces a prediction score that provides a rank per person that may be used by the relationship ranking module 106 to sort by. Machine learning ranking based on prediction score may be overridden based on other social networking features, such as connected users that have been hidden from a feed.

Using the prediction model generated by the relationship ranking module 106, the social networking system may identify other users connected to a viewing user, associated with the candidate set of user profile objects 114, as suggestions for relationship modification and present those suggestions in a relationship presentation module 118. The relationship presentation module 118 may include a user interface to be provided for display on the viewing user device 102 in which the user may select one or more suggestions to modify the relationship between the suggestions and the viewing user. In one embodiment, the relationship presentation module 118 may enable a viewing user to select from a list of options to mark the connected user as an acquaintance, add the connected user to a predetermined list of friends, or remove the user as a connection on the social networking system 100. In another embodiment, the relationship presentation module 118 may enable the viewing user to select on a first link that complete removes the connected user as a connection on the social networking system 100 and a second link that marks the connected user as an acquaintance. The relationship presentation module 118 may display in the user interface the profile photo, name, and other information obtained from the candidate set of user profile objects 114 that were identified by the relationship ranking module 106.

The relationship modification module 116 may apply these changes received from the viewing user device 102 through the user interface provided by the relationship presentation module 118 by modifying edge objects 110 associated with the viewing user and selected connected users according to the changes received. For example, if a viewing user indicated through user input in the user interface that the candidate user for relationship modification should be removed completely as a connection, then the relationship modification module 116 would terminate the connection between the viewing user and the target user. In one embodiment, the changes are immediately made on the edge objects 110 in real-time. In another embodiment, the relationship modifications made by the viewing user device 102 are implemented in a separate process in which the user profile object 108 associated with the viewing user as well as the edge objects 110 associated with the viewing user and selected connected users are modified to reflect the selected changes. In marking a connected user as an acquaintance, the viewing user will receive less content items published by the marked user in the viewing user's news feed or communication channel from the social networking system 100. In addition, marking a connected user as an acquaintance provides an additional benefit of enabling a viewing user to publish content items to a more targeted audience by excluding connected users marked as acquaintances. By marking a connected user for removal, the viewing user will no longer be connected to the marked user on the social networking system 100, meaning that access privileges to the content items shared by the viewing user on the social networking system 100 will be revoked for the marked user and vice versa.

### System Architecture

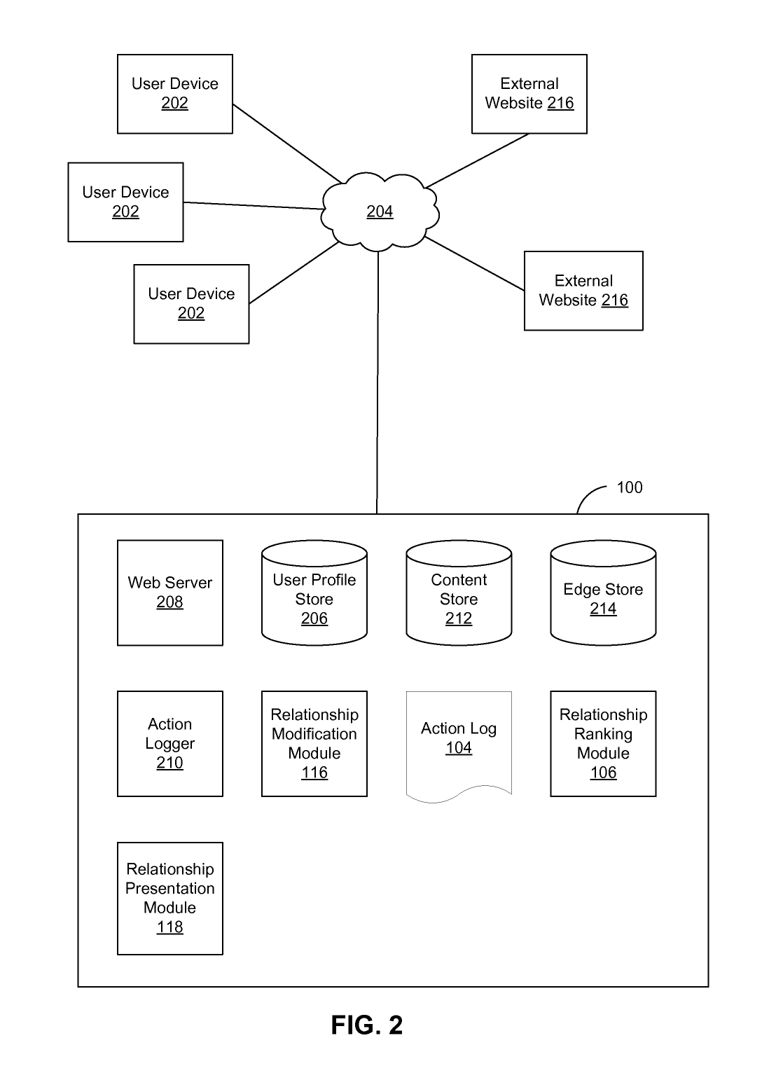

FIG. 2 is a high level block diagram illustrating a system environment suitable for suggesting relationship modifications to users of a social networking system, in accordance with an embodiment of the invention. The system environment comprises one or more user devices 202, the social networking system 100, a network 204, and external website 216. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, etc. The user device 202 is configured to communicate via network 204. The user device 202 can execute an application, for example, a browser application that allows a user of the user device 202 to interact with the social networking system 100. In another embodiment, the user device 202 interacts with the social networking system 100 through an application programming interface (API) that runs on the native operating system of the user device 202, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a user profile store 206, a web server 208, an action logger 210, a content store 212, an edge store 214, an action log 104, a relationship ranking module 106, a relationship modification module 116 and a relationship presentation module 118. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more user devices 202; the web server 208 serves web pages, as well as other web-related content, such as Java, Flash, XML, and so forth. The web server 208 may provide the functionality of receiving and routing messages between the social networking system 100 and the user devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native user device operating systems, such as iOS, ANDROID, webOS, and RIM.

The action logger 210 is capable of receiving communications from the web server 208 about user actions on and/or off the social networking system 100. The action logger 210 populates the action log 104 with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

User account information and other related information for a user are stored as user profile objects 108 in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. A user profile store 206 maintains profile information about users of the social networking system 100, such as age, gender, interests, geographic location, email addresses, credit card information, and other personalized information. The user profile store 206 also maintains references to the actions stored in the action log 104 and performed on objects in the content store 212.

An action log 104 may be used by a social networking system 100 to track users' actions on the social networking system 100 as well as external websites that communication information back to the social networking system 100. As mentioned above, users may interact with various objects on the social networking system 100, including commenting on posts, sharing links, and checking-in to physical locations via a mobile device. The action log 104 may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log 104 records data about these users, including viewing histories, advertisements that were clicked on, purchasing activity, and buying patterns.

The edge store 214 stores the information describing connections between users and other objects on the social networking system 100 in edge objects 110. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge store 214 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 214, in one embodiment. For example, a user that plays multiple songs from Lady Gaga's album, “Born This Way,” may have multiple edge objects for the songs, but only one edge object for Lady Gaga.

A relationship presentation module 118 provides a user interface for users of the social networking system 100 to select relationship modifications for a listing of candidate users. The user interface provided by the relationship presentation module 118 may include user profile information retrieved from user profile objects 108, recent user interactions between users retrieved from edge objects 110, as well as content objects 112 posted by the users. In one embodiment, the relationship presentation module 118 may include information about the relationship with the user, such as when the users connected on the social networking system 100, listing a specific event, such as a birthday party, after which the users became connected on the social networking system 100, the number of mutual friends shared between the source user and the target user, a listing of the mutual friends with links to their profiles on the social networking system 100, and content objects 112 in which the source user and the target user are both tagged in or otherwise associated with, such as photos, videos, events attended, check-in events, notes, applications used, and locations visited. In another embodiment, graph objects that the target user and the source user have both interacted with, such as song objects played through an external music streaming service, news articles read through an application on the social networking system 100, or books purchased on an external website, may be presented by the relationship presentation module 118. In yet another embodiment, the relationship presentation module 118 may provide a user interface that provides the profile photo, name, location, and social graph information (such as a count of mutual friends) for each of the target users in a photo gallery format, showing multiple profiles of target users at a time.

A relationship ranking module 106 may rank a candidate set of user profile objects 114 for display to a viewing user. In one embodiment, the relationship ranking module 106 ranks the candidate set of user profile objects 114 by prediction values that estimate the likelihood of the viewing user modifying the relationship with the connected users associated with the candidate set of user profile objects 114. The relationship ranking module 106 may generate a prediction model that includes various features of the viewing user and the viewing user's connections on the social networking system 100, or the target user's features. For example, the time since a target user last logged into the social networking system 100 may be a very strong indicator of whether the viewing user may decide to modify the relationship with the target user. Inactive users or users that seldom use the social networking system may be prime candidates for a viewing user to indicate that those users are merely acquaintances or should be removed as a connection.

Another feature that may be included in the prediction is a friendship age between the target user and the viewing user (or source user). The friendship age may be determined as the duration of time that has elapsed since the target user and the source user have become connected on the social networking system 100. Old friendship age may indicate that the users have a stronger friendship as opposed to a relatively young friendship age. In one embodiment, a friendship age below a predetermined threshold age may be a strong indicator that the source user may modify the relationship by marking the target user as an acquaintance or removing the target user as a connection.

The actual legal age of a target user may also be a factor in the prediction model for suggesting relationship modifications. Target users of ages that are less represented on the social networking system 100 may be inferred to be distant friends. For example, users younger than 8 as well as user older than 80 may be inferred to be distant friends of their connected users. A machine trained model may indicate that the legal age of a target user may help predict the outcome based on an observation that people tend to socialize with other users in their age group. Legal age differences between the target user and the source user may also be used as a separate factor in the prediction model for suggesting relationship modifications. For example, users with ages of large variances, such as 20 years, may be distant friends as a result of generational gaps.

Another factor in the prediction model for suggesting relationship modifications for a source user includes the number of user connections for the source user. A large number of user connections for the source user may indicate that the source user is prone to making weaker connections with mere acquaintances or distant friends. In such a case, the prediction model may incorporate an additional weight proportional to the number of user connections of the source user in prediction scores for the target users. For example, if a source user has 1,126 user connections, or “friends,” on the social networking system 100, an additional weight may be added to prediction scores for target users that may be suggested for relationship modification. In one embodiment, the additional weight may be determined based on the variance between the number of user connections for the source user and an average number of user connections for users of the social networking system 100. In another embodiment, the additional weight may be computed using the machine trained prediction model. Similarly, the number of user connections on the social networking system of the target user may be included as a separate factor in the prediction model for suggesting relationship modifications.

The number of mutual friends between the target user and the source user may also be used as a factor in the prediction model for suggesting relationship modifications. A low number or no mutual friends between the target user and the source user may indicate that the connection is weak and that the target user is a mere acquaintance or a distant friend. On the other hand, a high number of mutual friends may, in one embodiment, merely indicate that the target user and source user participate in a community organization or alumni group in which all the mutual friends belong. The social networking system 100 may determine this based on the mutual friends, the target user and the source user expressing interest in a page for the community organization or alumni group. In another embodiment, a number of mutual friends in a predetermined range may indicate that the target user and the source user are more than mere acquaintances. This range may be determined by the social networking system using machine learning methods.

The amount of time that has passed since the target user first joined the social networking system, or the social networking system age of the target user, may be used as a factor in the prediction model for suggesting relationship modifications. Users that are new to the social networking system 100 may be prone to making user connections to people that they do not know very well or have briefly met. As a result, those target users may be more likely to be suggested for relationship modification.

A common friend ratio with respect to the source user's total user connections on the social networking system may be used as a factor in the prediction model for suggesting relationship modifications. The common friend ratio with respect to the source user's total user connections on the social networking system may be computed as the number of mutual friends between the source user and the target user divided by the source user's total number of user connections on the social networking system. This ratio may indicate a percentage of the source user's total number of user connections on the social networking system that are mutual friends with the target user. Based on a predetermined threshold, the ratio may be used as a factor in the prediction model if the ratio is below the threshold, in one embodiment. In another embodiment, the ratio may be used in a formula for determining a weight of a factor in the prediction model. Similarly, a common friend ratio with respect to the target user's total number of connections on the social networking system may also be used as another factor in the prediction model for suggesting relationship modifications. In one embodiment, a common friend ratio may be normalized by computing the square of the total number of friends in common divided by the product of each user's total number of friends. This normalized common friend ratio may be used as a separate factor in the prediction model for suggesting relationship modifications.

Further, the amount of time that has elapsed since the target user last updated his or her profile may be used as a factor in the prediction model for suggesting relationship modifications to the source user. Users of a social networking system may regularly update their profiles by engaging and interacting with other objects on the social networking system. If the amount of time that has elapsed since the target user last updated his or her profile exceeds a predetermined threshold, then a weight may be added to a prediction score for that target user.

### Selecting Relationship Modifications Based on Relationship Ranking

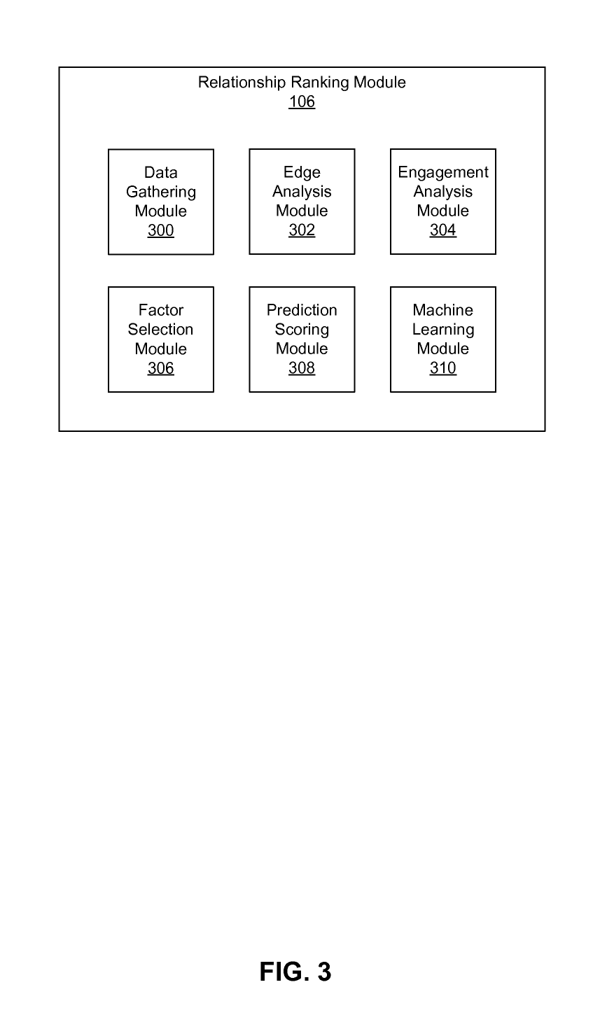

FIG. 3 illustrates a high level block diagram of the relationship ranking module 106 in further detail, in one embodiment. The relationship ranking module 106 includes a data gathering module 300, an edge analysis module 302, an engagement analysis module 304, a factor selection module 306, a prediction scoring module 308, and a machine learning module 310. These modules may perform in conjunction with each other or independently to develop a predictive model of inferring household income for users of a social networking system 100.

A data gathering module 300 accesses various objects on the social networking system 100 to gather data about relationships between users of the social networking system 100. These objects include user profile objects 108, edge objects 110, content objects 112, and the action log 104. Additionally, the data gathering module 300 may, in one embodiment, gather information about users and their actions taken on external websites that are connected to the social networking system 100 through the use of plug-ins on their websites. For example, a user may log into a live music concert website using a plug-in that allows information to be shared between that external website and the social networking system 100. If the user chooses to purchase concert tickets to the next Britney Spears concert on the external website, the social networking system 100 may record that information and store an interest in Britney Spears in the user profile information object associated with the user, in one embodiment. This information may then be used in a factor in a predictive model for suggesting relationship modifications to users of the social networking system 100, such as using interest affinities in determining whether friends are mere acquaintances.

The edge analysis module 302 may analyze interactions between a target user and a source user to determine an affinity score of the source user for the target user. This affinity score may be used as a factor in a prediction model for suggesting relationship modifications to users on the social networking system 100. For example, if a source user that has a low affinity score for a target user, based on a predetermined threshold, that may be used as a factor in the prediction model for suggesting relationship modifications to the source user. In one embodiment, the edge analysis module 302 may also be used to identify mutual friends between the source user and the target user to determine the number of mutual friends, a ratio of mutual friends to total number of friends of the source user, and a ratio of mutual friends to total number of friends of the target user. In another embodiment, the edge analysis module 302 may be used to identify the number of shared interests expressed by the source user and target user by identifying edges to those shared interests in the social graph. Because interests, such as Britney Spears and Baseball, may be represented on the social networking system 100 as objects, or nodes, the user profile objects associated with the target user and source user may also be associated with the objects for these interests through edge objects 110. As a result, the edge analysis module 302 may determine, as a factor in a prediction model for suggesting relationship modifications, whether the target user and source user share the same affinity for the same interests.

An engagement analysis module 304 analyzes the actions performed by the target user and the source user, including interactions between the users, interactions with other users, and interactions with content on the social networking system, to determine levels of engagement in the social networking system 100. These levels of engagement may be used as a factor in the prediction model for suggesting relationship modifications to the source user, in one embodiment. For example, the social networking system 100 may have a metric to measure engagement, such as measuring the time that has elapsed since the target user last updated his or her profile, average amount of time spent being active on the social networking system, and an average amount of activity or interactions produced by users in a given time period (e.g., month, week, day, hour). If a target user exhibits low engagement, based on a predetermined threshold, that low engagement may be a factor in the prediction model for suggesting a relationship modification for the target user to the source user.

A factor selection module 306 enables the selection of factors by administrators of the social networking system 100 through a user interface or through an application programming interface (API), in one embodiment. In another embodiment, factors may be selected and deselected using machine learning techniques. For example, a factor such as the period of time that has elapsed since a target user last updated his or her profile may be initially included in the prediction model, but then over time, the factor may be deselected because machine learning techniques have indicated that the factor is not longer relevant to predicting whether a target user's relationship with a source user should be modified. In a further embodiment, the factors may be a pre-selected by administrators of the social networking system 100 and then refined using machine learning techniques.

A prediction scoring module 308 uses the factors selected in the prediction model to determine a score for target users associated with the source user. As mentioned above, various factors may be selected for the prediction model, including the time elapsed since the target user last logged into the social networking system 100, the age of the friendship on the social networking system 100 between the target user and the source user, the legal age of the target user, the number of friends of the source user, the number of friends of the target user, the number of common friends between the target user and the source user, how long the target user has been using the social networking system 100, a common friend ratio with respect to the source user's total number of friends on the social networking system, a common friend ratio with respect to the target user's total number of friends on the social networking system, the time elapsed since the target user last updated his or her profile, and the difference in age of the target user and the source user. The prediction model may also include factors such as an analysis of the interests shared by the target user and source user, an analysis of the affinity for the target user by the source user and an analysis of the engagement by the target user in the social networking system.

The prediction scoring module 308 produces a prediction score that indicates whether a target user should be suggested for a relationship modification to the source user. In one embodiment, a predetermined threshold score may be used to determine whether the target user should be suggested for a relationship modification, such as marking the target user as an acquaintance or removing the target user as a connection. In another embodiment, there are separate predetermined thresholds for the different types of relationship modification. In this way, relationships between target users and the source user are ranked such that the highest prediction scores are for target users that are being suggested for relationship modification.

In another embodiment, the prediction scoring module 308 produces a prediction score that indicates whether the user is likely to interact with or view the content of another user. Using this prediction of whether the user will interact or otherwise engage with the content of other users, the social networking system may suggest reclassification of the other users. For example, the prediction model may examine the content of other users and determine whether the interests of those users will be relevant to the viewing user based on the examined content. In a further embodiment, the prediction scoring module 308 may examine a past history of interactions with connected users, including recent interactions and/or views of the connected users, to determine a prediction score of whether the viewing user will engage with connected users.

A machine learning module 310 may be used in the relationship ranking module 106 to refine the prediction model and the factors selected for the prediction model. In one embodiment, a social networking system 100 uses a machine learning algorithm to analyze the clicking behavior of source users using the user interface to “clean up,” or otherwise regulate and maintain, their connections to other users on the social networking system by marking user connections as acquaintances or removing user connections to retrain the prediction model. Using this feedback from the user interface of the relationship modification user interface, the prediction model may be refined to include more or less factors and the weights, or coefficients, assigned to each factor can also be adjusted based upon the response, i.e., the click-through behavior of the source users. In another embodiment, users may define “friend lists” on the social networking system 100, or subsets of all the user connections for a viewing user on the social networking system 100. Some friend lists may be automatically populated by the social networking system 100, such as friend lists of users that declare attending the same college and/or university that the viewing user declared attending. Other friend lists may be manually created by the viewing user. A machine learning module 310 may assist in automatically populating various friend lists, such as a “suggested acquaintance” friend list, a “suggested removal” friend list, a “close friend” friend list, a “party” friend list, a “professional” friend list, and so on. In this way, the social networking system 100 may beneficially help a viewing user organize the user experience on the social networking system 100.

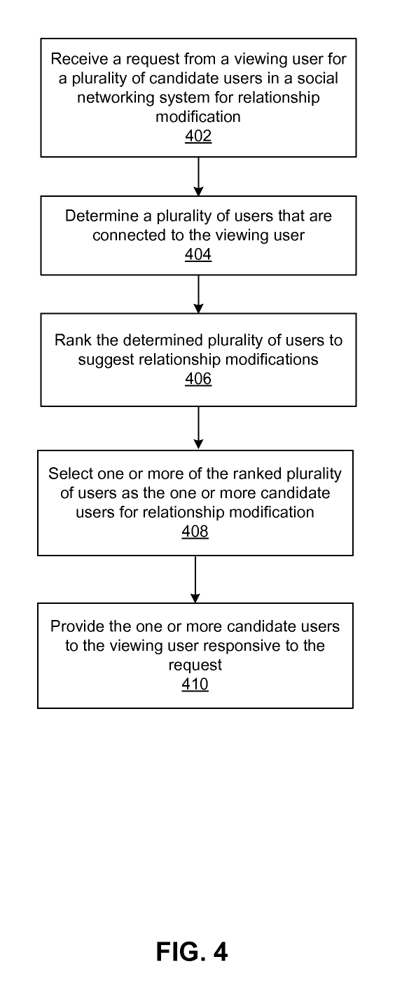

FIG. 4 illustrates a flow chart diagram depicting a process of suggesting relationship modifications to users of a social networking system, in accordance with an embodiment of the invention. A request is received 402 from a viewing user for a plurality of candidate users in a social networking system for relationship modification. The request may be received 402 through a web request from a web browser on a user device or through an application programming interface (API) call from a mobile device connected to the social networking system 100.

After the request for a plurality of candidate users for relationship modification is received 402, a plurality of users that are connected to the viewing user is determined 404. In one embodiment, the social networking system may determine the connected users through information in the user profile object 108 associated with the viewing user. In another embodiment, edge objects 110 associated with the user profile object 108 associated with the viewing user may also be used to determine 404 the plurality of users connected to the viewing user. In a further embodiment, the plurality of users connected to the viewing user is preprocessed to exclude users for which the viewing user has a high affinity score for based on a predetermined threshold affinity score. This preprocessing reduces the computing resources needed to produce suggestions for relationship modifications to the viewing user.

After the plurality of users that are connected to the viewing user have been determined 404, the determined plurality of users are ranked 406 to suggest relationship modifications. Using a prediction model that includes various factors, as mentioned above, prediction scores are determined for ranking 406 the determined plurality of users to suggest relationship modifications. The ranking 406 may be performed by the relationship ranking module 106, in one embodiment. In another embodiment, the affinity scores of the plurality of users connected to the viewing user may be used for the ranking 406.

Once the determined plurality of users have been ranked 406 to suggest relationship modifications, one or more of the ranked plurality of users are selected 408 as the one or more candidate users for relationship modification. The one or more candidate users for relationship modification are selected 408 using predetermined threshold prediction scores, in one embodiment. In another embodiment, a top percentage of the ranked plurality of users is selected 408 as the one or more candidate users for relationship modification. In yet another embodiment, different predetermined thresholds are used for different types of relationship modification. For example, a lower threshold may be used to select 408 users connected to the viewing user that may be mere acquaintances. A higher threshold may be used to select 408 users connected to the viewing user that should be suggested for removal of the connection on the social networking system 100. Similarly, lower top percentiles of ranked users may be selected 408 for a relationship modification of complete removal as connections to the viewing user, and higher top percentiles of ranked users may be selected 408 for a relationship modification of marking as an acquaintance.

After the one or more candidate users for relationship modification have been selected 408, the one or more candidate users are provided 410 to the viewing user responsive to the request. In one embodiment, the one or more candidate users are provided 410 in a user interface on a web browser operating on a user device associated with the viewing user. In the user interface provided 410 to the viewing user, the viewing user may indicate that his or her relationship with the provided candidate users should be modified. In another embodiment, the one or more candidate users are provided 410 for display in a user interface embodied in a mobile application through application programming interfaces (API) with the social networking system 100.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a request for a plurality of candidate users for relationship modification in a social networking system, where the plurality of candidate users are connected to a viewing user of the social networking system;
determining a plurality of users connected to the viewing user;
ranking the determined plurality of users for suggesting relationship modifications to the viewing user;
selecting one or more of the ranked plurality of users as candidate users for relationship modification; and
providing the one or more candidate users to the viewing user responsive to the request.

2. The method of claim 1, wherein ranking the determined plurality of users for suggesting relationship modifications to the viewing user further comprises:
determining a prediction score for each of the determined plurality of users using a prediction model for suggesting relationship modifications; and
ranking the determined plurality of users based on the prediction score.

3. The method of claim 1, wherein selecting one or more of the ranked plurality of users as candidate users for relationship modification further comprises:
determining one or more candidate users as a top percentage of the plurality of users based on the ranking.

4. The method of claim 1, wherein:
ranking the determined plurality of users for suggesting relationship modifications to the viewing user further comprises determining a prediction score for each of the determined plurality of users using a prediction model based upon information retrieved about the determined plurality of users, and
selecting one or more of the ranked plurality of users as candidate users for relationship modification further comprises determining one or more candidate users as a subset of the determined plurality of users having prediction scores exceeding a predetermined threshold.

5. The method of claim 1, wherein providing the one or more candidate users to the viewing user responsive to the request further comprises:
providing a user interface for modifying relationships between the viewing user and the one or more candidate users, the user interface comprising the one or more candidate users.

6. The method of claim 5, wherein the viewing user is enabled to disconnect relationships between the viewing user and the one or more candidate users using the user interface.

7. The method of claim 5, wherein the viewing user is enabled to lessen relationship statuses between the viewing user and the one or more candidate users using the user interface.

8. The method of claim 1, wherein ranking the determined plurality of users for suggesting relationship modifications to the viewing user further comprises:
ranking the determined plurality of users based on affinity scores of the viewing user for the determined plurality of users.

9. A method comprising:
receiving information about a target user and a source user of a social networking system, where the target user and the source user have a connection in the social networking system;
retrieving a prediction model for suggesting relationship modifications, the prediction model comprising a plurality of factors;
determining a prediction score for the target user based on the information about the target user and the source user applied to the plurality of factors in the retrieved prediction model for suggesting relationship modifications; and
storing the prediction score for the target user in an edge object associated with the target user and the source user.

10. The method of claim 9, further comprising:
responsive to the prediction score exceeding a predetermined threshold for relationship modification, providing information about the target user for display in a user interface to the source user for modifying the connection between the target user and the source user in the social networking system.

11. The method of claim 9, wherein a factor of the prediction model comprises a period of time elapsed since the target user last logged into the social networking system.

12. The method of claim 9, wherein a factor of the prediction model comprises a period of time elapsed since the target user and the source user formed the connection in the social networking system.

13. The method of claim 9, wherein a factor of the prediction model comprises a legal age of the target user.

14. The method of claim 9, wherein a factor of the prediction model comprises a count of other users in the social networking system connected to the source user.

15. The method of claim 9, wherein a factor of the prediction model comprises a count of other users in the social networking system connected to the target user.

16. The method of claim 9, wherein a factor of the prediction model comprises a count of other users in the social networking system connected to the source user and the target user.

17. The method of claim 9, wherein a factor of the prediction model comprises a period of time elapsed since the target user became a user of the social networking system.

18. The method of claim 9, wherein a factor of the prediction model comprises a ratio of a first count of other users in the social networking system connected to the source user and the target user in relation to a second count of other users in the social networking system connected to the source user.

19. The method of claim 9, wherein a factor of the prediction model comprises a ratio of a first count of other users in the social networking system connected to the source user and the target user in relation to a second count of other users in the social networking system connected to the target user.

20. The method of claim 9, wherein a factor of the prediction model comprises a period of time elapsed since the target user last updated a user profile on the social networking system associated with the target user.

21. The method of claim 9, wherein a factor of the prediction model comprises an age difference between the target user and the source user.

22. The method of claim 9, wherein a factor of the prediction model comprises an analysis of shared interests of the target user and the source user.

23. The method of claim 9, wherein a factor of the prediction model comprises an analysis of engagement level on the social networking system of the target user.

24. The method of claim 9, wherein a factor of the prediction model comprises an affinity score of the target user for the source user.

25. A method comprising:
selecting a plurality of factors in a prediction model for suggesting relationship modifications for users in a social networking system;
selecting a first plurality of weights for the selected plurality of factors in the prediction model;
receiving user feedback for the prediction model;
determining a subset of the plurality of factors in the prediction model based on the received user feedback;
redefining the prediction model to comprise the determined subset of the plurality of factors;
determining a second plurality of weights for the subset of the plurality of factors in the prediction model based on the received user feedback; and
storing the second plurality of weights and the prediction model in a computer readable storage medium communicatively coupled with the social networking system.

26. The method of claim 25, wherein the determined subset of the plurality of factors results from using machine learning.

27. A method comprising:
receiving a request for a plurality of candidate users for relationship modification in a social networking system, where the plurality of candidate users are connected to a viewing user of the social networking system;
receiving information about a plurality of target users connected to the viewing user;
retrieving a prediction model for predicting engagement with user content, the prediction model having a plurality of factors;
determining a prediction score for each of the plurality of target users based on information about the target user and the viewing user applied to the plurality of factors in the retrieved prediction model for predicting engagement with user content;
selecting one or more of the plurality of target users as candidate users for relationship modification based on prediction scores of the selected target users;
providing the one or more candidate users to the viewing user responsive to the request.

28. The method of claim 27, wherein a factor in the prediction model for predicting engagement with user content further comprises:
determining a plurality of shared interests between a target user and a viewing user.

29. The method of claim 27, wherein a factor in the prediction model for predicting engagement with user content further comprises:
analyzing historical interactions between a target user and a viewing user.
